(19) United States
(12) Patent Application Publication
(10) Pub. No.: US 2003/0185643 A1
(43) Pub. Date: Oct. 2, 2003

(54) Flexible bridge for a strut nut

(76) Inventor: William J. Thompson, Newport Beach, CA (US)

Correspondence Address: SNELL & WILMER LLP, 1920 MAIN STREET, SUITE 1200, IRVINE, CA, 92614-7230, US

(21) Appl. No.: 10/114,600

(22) Filed: Apr. 2, 2002

(51) Int. Cl. F16B 27/00

(52) U.S. Cl. 411/85

(57) ABSTRACT

The present invention is a flexible bridge that positions a strut nut in a C-shaped mounting channel. The flexible bridge is graspable between a thumb and forefinger for rapid positioning, and converts to an anti-rotation device that prevents the strut nut from rotating within the channel. A harness supports the strut nut while a flexure member provides a grippable location to position the harness and strut nut combination at a desired location within the channel. The flexure member remains outside of the channel while the strut nut and harness are disposed within the channel, and at least a portion of the flexure member has a dimension greater than the width of the channel. This dimension prevents the flexible bridge from withdrawing into the channel when the strut nut is in place in the channel. The flexure member converts to an anti-rotation mechanism for preventing the strut nut from rotating within the channel during engagement with the threaded member.

### BACKGROUND OF THE INVENTION

1. Field of the Invention

The present invention is directed generally to a strut nut securing mechanism for a channel or strut assembly, and more particularly to a flexible bridge for a strut nut that spans the opening of the channel and secures the strut nut during installation.

2. Description of Related Art

A U-shaped channel, also known as a strut, is a standard building component used to suspend and support items such as electrical cables, plumbing pipes, and heating ducts in a building. The channels can also be used to mount air conditioning units, heaters, lighting, and other equipment that is suspended from a wall or ceiling. Descriptions of the U-shaped channels and its application is described in U.S. Pat. No. 6,290,426 to van Gijsel et al., and in U.S. Pat. No. 5,489,173 to Höfle, and both of these references are incorporated by reference in their entireties herein.

Typically an elongate threaded member such as a bolt or threaded rod is used to suspend the channel from an elevated supporting structure. The bolt or threaded rod connects to the channel using a strut nut that engages the inner portion of the channel. To facilitate this engagement it is preferable that the strut nut is positioned securely at a relatively fixed location within the channel at an upper surface, but this criteria may be difficult to arrange in certain orientations because the strut nut will drop to the bottom of the channel unless something prevents the strut nut from dropping. Even in situations where gravity initially aids in the strut nut position, such as when the channel is upside down, the absence of any counteracting force will prevent the strut nut from simply being lifted up by the threaded rod instead of engaging the rod in a threaded relationship. Accordingly, there has been a significant effort to design a device that will fix the strut nut quickly in the channel when the channel is in any orientation. Strut nuts with coiled spring components that bias the strut nut against the upper portion of the channel solve the initial problem, but springs can become misaligned or fail to resist the axial force from the threaded rod. Other attempts to suspend the strut nut inside the channel from an anchor located predominantly outside the channel (see Höfle and van Gijsel et al., supra) are more reliable than spring solutions, but lack the benefits of the present invention.

### SUMMARY OF THE INVENTION

The present invention is a flexible bridge that supports and cradles a strut nut to be engaged with a threaded rod or bolt and prevents the strut nut from rotating within the channel. A harness supports the strut nut while a flexure member provides a grippable location to position the harness and strut nut combination at a desired location within the channel. The flexure member remains outside of the channel while the strut nut and harness are disposed within the channel, and at least a portion of the flexure member has a dimension greater than the width of the channel. This dimension prevents the flexible bridge from withdrawing into the channel when the strut nut is in place in the channel. The flexure member converts to an anti-rotation mechanism for preventing the strut nut from rotating within the channel during engagement with the threaded member.

### BRIEF DESCRIPTION OF THE DRAWINGS

The exact nature of this invention, as well as its objects and advantages, will become readily apparent upon reference to the following detailed description when considered in conjunction with the accompanying drawings, in which like reference numerals designate like parts throughout the figures thereof and wherein:

FIG. 1 is an elevated, perspective view of a flexible bridge of the present invention illustrating its relationship with a threaded member, a strut nut, and a strut channel;

FIG. 2 is a side view with the channel partially cut away illustrating the relationship between the flexible bridge, the strut nut, and the strut channel when the strut nut is positioned within the channel;

FIG. 3 is a bottom view of the flexible bridge and strut nut assembly;

FIG. 4 is a top view of the flexible bridge and strut nut as it is initially located in the channel;

FIG. 5 is a top view of the flexible bridge and strut nut after the flexible bridge is rotated ninety degrees within the channel;

FIG. 6 is an elevated perspective view of the flexible bridge grasped between a thumb and forefinger for locating the strut nut and flexible bridge within the channel;

FIG. 7 is a side view with the channel partially cut away illustrating how the wings of the flexible bridge fold downward to comprise an anti-rotation mechanism that straddles the strut nut; and

FIG. 8 is a front view of the flexible bridge with the channel partially cut away to show the anti-rotation feature of the flexible bridge, shown further deflected by the presence of a washer.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a locking mechanism for a strut nut/channel assembly.

FIG. 1 illustrates a preferred embodiment of the present invention comprising a flexible bridge supporting a strut nut for a channel shaped strut. The channel has a rectangular profile and includes a base panel and two side panels terminating in an inward one hundred and eighty degree curl, such that the ends of the side panels point toward the base panel. The base panel may include a plurality of spaced apart holes used to accommodate fasteners that secure the channel to a surface such as a wall or ceiling structure. Fasteners are passed through the channel's spaced apart holes and into preset holes in the wall or ceiling structure to mount the channel thereto. The space between the curled ends of the side panels define an slot-like opening in the channel, and the curl at the end of the side panels on the channel are squared off such that there is a flat surface on the channel at its opening. The ends of the side panels are spaced apart to cooperate with a set of grooves on a strut nut and the distance between the two upturned edges is a well established value.

A strut nut typically comprises a rectangular body with a threaded passage for receiving a threaded member thereinthrough. Parallel grooves are provided along a surface to mate with the edges of the channel ends and orient the strut nut in a particular direction within the channel. Once engaged with the threaded member, the strut nut helps anchor the threaded member to the strut or channel at the opening by restricting the movement of the threaded member away from the channel by virtue of the contact between the strut nut at the grooves with the ends of the channel side walls.

When the strut nut is initially positioned within the channel for engagement with a threaded member, manual access to the strut nut may be difficult or impossible because the channel opening is small compared to a human hand and will likely be further obstructed by the threaded member and other components. When the channel is mounted on a ceiling or wall structure, gravity will make it difficult to correctly position the strut nut within the channel. The present invention provides a mechanism for fixing the strut nut within the channel quickly and precisely, preventing the strut nut from slipping or falling out of position before the threaded member can be engaged.

To fix the strut nut within the channel, a flexible bridge is provided that connects to the strut nut via a fitted harness or sleeve. The harness supports and confines the movement of the strut nut and connects the strut nut to the flexible bridge. The harness comprises a sleeve that wraps around the strut nut, where the sleeve is partially formed by two branches that diverge from an annular platform disposed above the strut nut. The two branches diverge at each side of the strut nut into separate bands extending across the bottom surface of the strut nut, each band disposed on an opposite side of the threaded opening. The divergence provides sufficient clearance for the threaded member to pass through the bottom of the strut nut (see FIG. 3) and out of the harness. The two branches of the harness cradle the strut nut and provide support against the axial and circumferential force of the threaded member during insertion. Each branch of the harness has lateral edges integral with the lower bands to form a rectangular profile that fits the strut nut snugly preventing slippage of the strut nut within the harness.

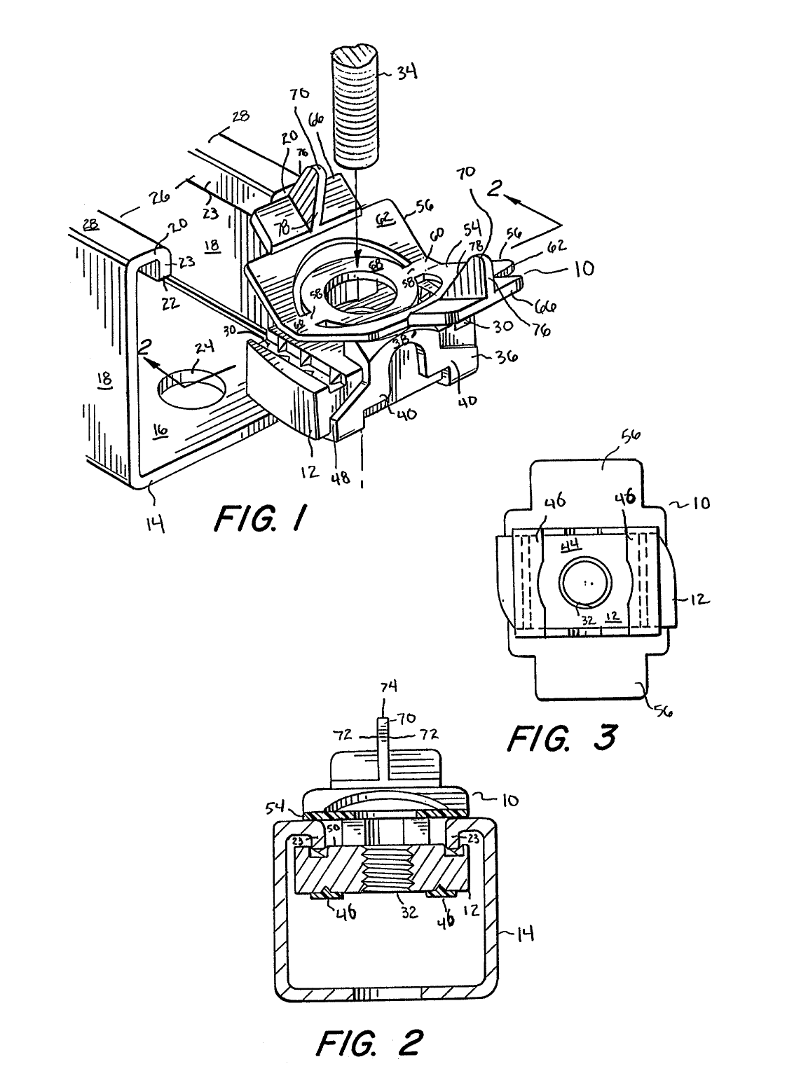

The annular platform is adapted to contact the upper surface of the strut nut and provide further support as the strut nut is held from above and below between the annular platform and the lower bands, and from side to side between the opposed lateral edges of the separate branches. The annular platform comprises two semi-circular walls that cooperate to serve as a spacer that provides clearance between the engagement of a complimentary locking nut and the strut nut. The height of the semi-circular walls is selected to provide clearance that coincides with the distance between the locking nut and the upper surface of the channel when the grooves of the strut nut are engaged on the edges of the channel as shown in FIG. 2.

Mounted at the top of the annular platform is flexure member comprising first and second wings that are mirror images of each other. The flexure member is connected to the annular platform by a pair of linking members aligned linearly with a pair of creases in the flexure member. The first and second wings are preferably formed to be slightly inclined with respect to a planar configuration; that is, each wing is tilted slightly out of plane away from the annular platform as shown in FIG. 1. Each wing includes an inner rectangular frame with a semi-circle cut-away portion to accommodate the annular platform, and an outer rectangular tab integrally formed thereto. The inner rectangular frame is preferably thinner than the outer rectangular tab to promote the flexure of the wing, while the increased thickness of the outer rectangular tab provides a sturdier element that will maintain its shape and provide a good grippable surface. The respective wings are preferably integrally formed with each other and with the linking members, and at least a portion of the annular platform. For example, FIG. 1 shows a circular top of the annular base integrally formed with linking members that are integrally formed with first and second wings.

The flexure member can be folded inward at a crease along the juncture between the inner rectangular frames such that the respective outer rectangular tabs of the first and second wings are brought in proximity with each other. This feature allows the flexure member, and thus the flexible bridge, to be grasped easily and securely between a thumb and forefinger. As the first and second wings are brought in proximity with each other, projections perpendicular to the outer rectangular tabs and aligned radially with respect to the threaded passage interfere with each other and prevent the ends of the first and second wings from contacting each other. This engagement between the perpendicular projections provides a gap defined by the collective height of the two perpendicular projections between the first and second wing members while being grasped between a thumb and forefinger. This gap makes the gripping of the flexible bridge easier than if the two wings compressed flat against each other. Alternatively, the first and second perpendicular projections may be aligned parallel but slightly offset from the common radial line they occupy such that, instead of interfering with each other, the projections bypass each other and contact the opposite outer rectangular tab instead. This reduces the gap distance to a single projection height, but is more stable since the interference between the two projections can be suddenly disturbed by a small lateral movement between the two wings while being gripped, causing the user to drop the flexible bridge. With the latter arrangement, the interference between the projections and their opposing outer rectangular tab cannot be disturbed by a slight lateral movement of the wings.

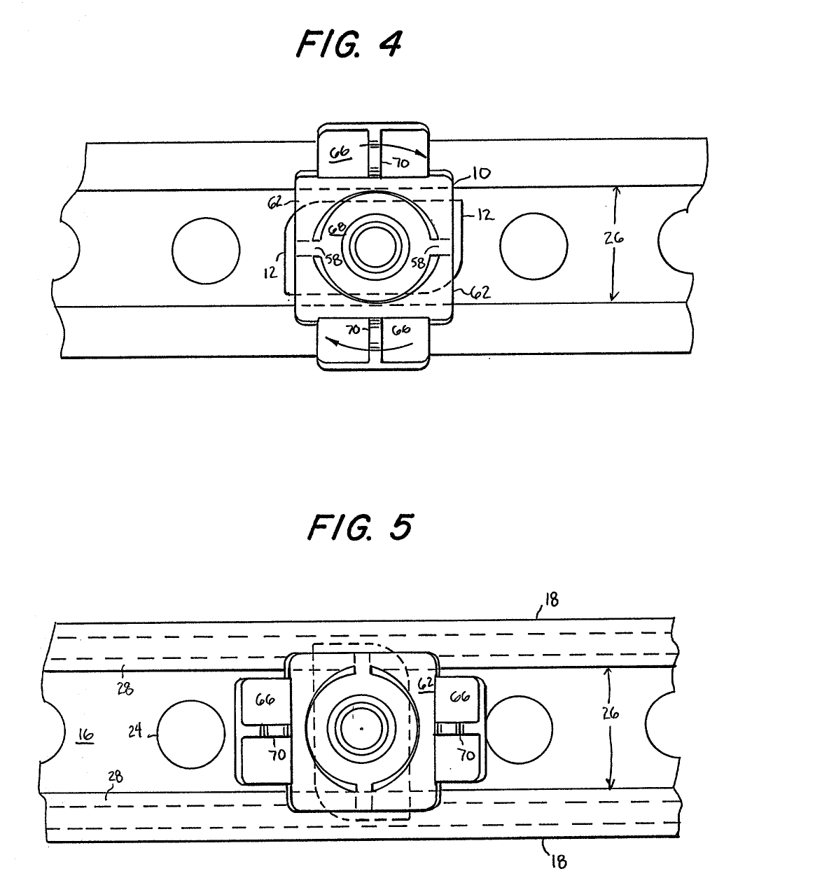

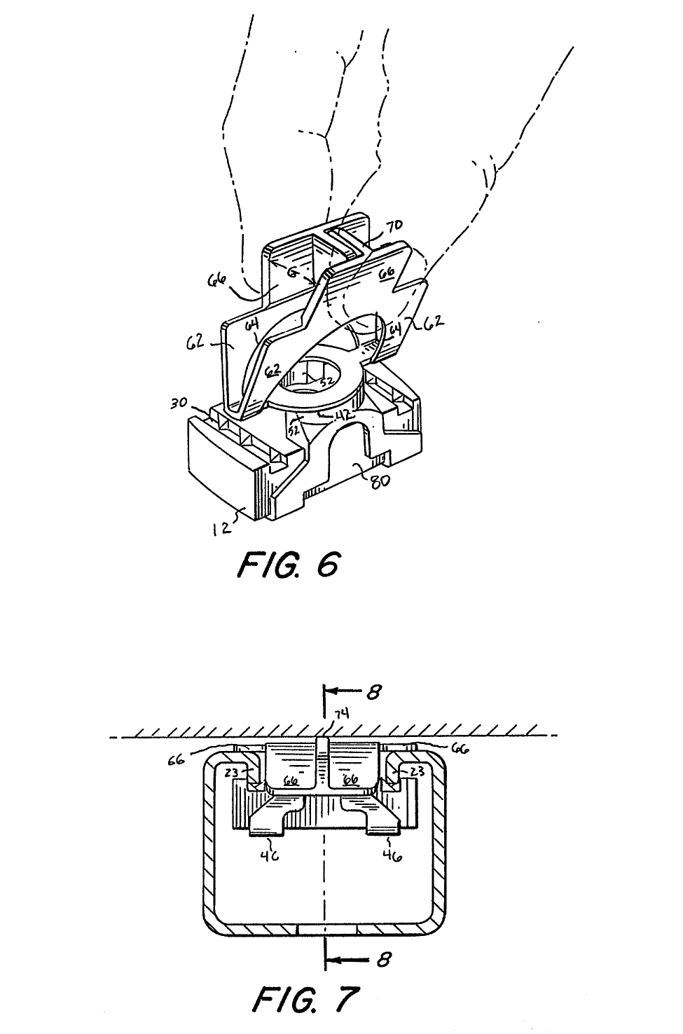

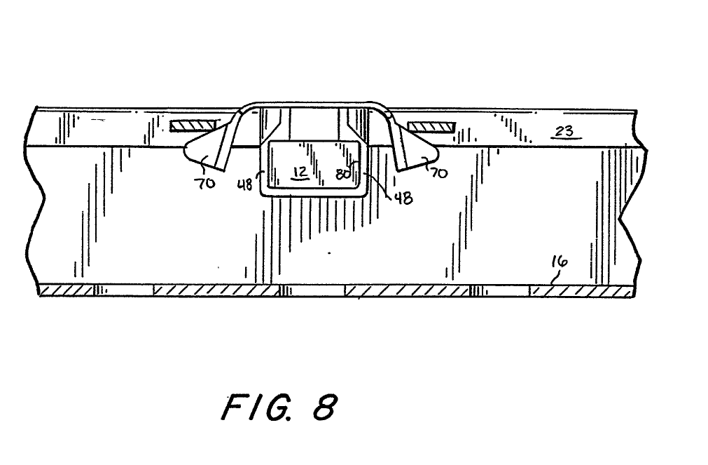

The perpendicular projections are preferably rounded at the top with a flat front and back face, with a first side that is perpendicular to the outer rectangular tab and a second side that has an inclined slope to the top. Once the flexible bridge is positioned within the channel, the outer rectangular tabs are released and the first and second wings return to their nominal position of a slightly inclined orientation. The strut nut can be positioned inside the channel as shown in FIGS. 4 and 5 by initially placing the strut nut and flexible bridge assembly longitudinally in the channel opening, sliding the strut nut and flexible bridge assembly to the desired location, and then rotating the flexure member from the outside of the channel thereby turning the strut nut ninety degrees within the channel. Once rotated, the strut nut grooves engage the upturned edges of the channel side walls while the flexure member spans the top of the channel, trapping the upturned edges of the channel side walls between the strut nut and the flexure member (FIG. 2). This “sandwiching” of the upturned edges fixes the strut nut in place within the channel without the need to grab or hold the strut nut manually, and permits the threaded member to be inserted into the strut nut and rotated therein to mate the strut nut with the threaded member. Whether the channel is vertical, horizontal, or upside down, the flexible bridge holds the strut nut in the desired position for quick and easy installation.

The perpendicular projections also serve as an anti-rotation mechanism that prevents the strut nut from rotating within the channel as the threaded member is inserted. Previously, as the strut nut tightens onto the threaded member a torque develops on the strut nut leading to an unwanted rotation of the strut nut unless an anti-rotation mechanism was present. In the present invention, a complimentary locking member such as a locknut is usually placed on the flexible bridge to secure a bracket or mounting plate disposed therebetween. As bracket or plate is placed over the flexible bridge, it contacts the uppermost portion of the flexible bridge, i.e., the perpendicular projections. The plate or bracket via contact with the projections forces the wings downward past horizontal and eventually slanted in a downward inclination with respect to a plane defined by the upper surface of the channel. While the inner rectangular frames are wide enough to overlap the opening of the channel, the outer rectangular tabs are narrower than the opening of the channel and are bent backwards by the force of the mounting bracket or plate on the perpendicular projections. With the tops of the projections co-planar with the top of the channel, the outer tabs are forced into a position straddling the sides of the strut nut. The presence of the outer tabs adjacent each side of the strut nut inhibit any rotation of the strut nut due to the torque imparted by the threaded member. Because the flexure member bends both inward and outward from its nominal location, it can facilitate grasping between the thumb and forefinger for locating the strut nut within the channel and then prevent the strut nut from rotating in the channel upon the application of a torque.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A flexible bridge for a strut nut assembly to fix a strut nut within a strut channel comprising:
a harness having a generally rectangular profile for holding a strut nut; and
a flexure member attached to the harness comprising first and second wings, said first and second wings flexing in a first direction to come in contact with each other, and flexing in an opposite direction resulting in a compressive force to straddle the harness and form an anti-rotation mechanism thereabout.

2. The flexible bridge of claim 1 further comprising a platform disposed between the flexure member and the harness for receiving a threaded member thereinthrough.

3. The flexible bridge of claim 2 wherein the platform comprises a pair of semi-circular walls that serve as a spacer.

4. The flexible bridge of claim 2 further comprising a pair of linking members to connect the first and second wings to the platform.

5. The flexible bridge of claim 2 wherein the first and second wings are inclined away from the platform in an unstressed condition.

6. The flexible bridge of claim 2 wherein each wing comprises an inner rectangular frame having a cut-away portion to accommodate the platform, and an outer rectangular tab integrally formed to the inner rectangular frame.

7. The flexible bridge of claim 2 wherein each wing includes a perpendicular projection with respect to and depending from an upper surface of said each wing.

8. The flexible bridge of claim 7 wherein the perpendicular projection is rounded along an upper surface, with a first side that is perpendicular to the outer rectangular tab and a second side that has an inclined slope from the inner rectangular frame to the rounded upper surface of the perpendicular projection.

9. The flexible bridge of claim 7 wherein the first and second wings are deflected downward thusly forming said anti-rotation mechanism when said perpendicular projections are brought co-planar with an upper surface of said platform.

10. A strut nut assembly comprising a strut nut and a strut nut locator for locating a strut nut within a strut channel, the strut nut locator comprising:
a harness having a generally rectangular profile for holding a strut nut; and
a flexure member attached to the harness comprising first and second wings, said first and second wings flexing in a first direction to come in contact with each other, and flexing in an opposite direction to straddle the harness and form an anti-rotation mechanism thereabout.

11. The flexible bridge of claim 10 further comprising a platform disposed between the flexure member and the harness for receiving a threaded member thereinthrough.

12. The flexible bridge of claim 11 wherein the platform comprises a pair of semi-circular walls that serve as a spacer.

13. The flexible bridge of claim 11 further comprising a pair of linking members to connect the first and second wings to the platform.

14. The flexible bridge of claim 11 wherein the first and second wings are inclined away from the platform in an unstressed condition.

15. The flexible bridge of claim 11 wherein each wing comprises an inner rectangular frame having a cut-away portion to accommodate the platform, and an outer rectangular tab integrally formed to the inner rectangular frame.

16. The flexible bridge of claim 11 wherein each wing includes a perpendicular projection with respect to and depending from an upper surface of said each wing.

17. The flexible bridge of claim 16 wherein the perpendicular projection is rounded along an upper surface, with a first side that is perpendicular to the outer rectangular tab and a second side that has an inclined slope from the inner rectangular frame to the rounded upper surface of the perpendicular projection.

18. The flexible bridge of claim 16 wherein the first and second wings are deflected downward thusly forming said anti-rotation mechanism when said perpendicular projections are brought co-planar with an upper surface of said platform.
